(19) United States
(12) Patent Application Publication
(10) Pub. No.: US 2005/0176367 A1
(43) Pub. Date: Aug. 11, 2005

(54) Wireless repeater with diverse communications interface capability and method of managing the same

(76) Inventors: Anthony Verloop, Hsichih City (TW); Alex Yuan, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/776,114

(22) Filed: Feb. 11, 2004

(51) Int. Cl. H04B 7/15

(52) U.S. Cl. 455/11.1

(57) ABSTRACT

A wireless repeater with a diverse communications interface capability and the method of managing the same, in which the wireless repeater is prepared with multiple wireless/mobile communications system drivers and can switch to an appropriate system driver to match the target system, that may only support a particular version of wireless communications protocols, running on a remote personal communications device, a mobile communications system, or a WLAN for establishing bi-directional communication between the personal computing device and the target system. Further, the wireless repeater can also be operated with a net phone (VoIP), and support infra-red transmission. Thus, the present invention accomplishes the goals of integrating a computer and a communications device under one system, reducing user's telephone rates and increasing system mobility.

### BACKGROUND OF THE INVENTION

1. Field of the Invention

The present invention is related to a wireless repeater with diverse communications interface capability, and more particularly to an RF repeater that can automatically detect and switch to an appropriate wireless communications interface compatible with the target system, that may only support a particular version of wireless communications protocols, for establishing bidirectional communication, and the method of managing multiple versions of communications system drivers.

2. Description of Related Art

Wireless communications technology has now become widely used in digital data communications and personal communications. Personal area networks (PANs) and wireless local area networks (WLANs) are some of the latest examples that the technology has to offer, which can provide high speed data transmission through open air and allow users to access the network resources from any place and at any time with no need of setting up the physical cable connections. An ordinary user is able to use a mobile phone, a personal digital assistant (PDA), a notebook computer or a flat panel computer to access the Internet domain. When the digital computer is configured with a Bluetooth module and a wireless repeater, it can be operated as a base station, through which a bi-directional communication link can be established with one or more mobile stations, such as cellular phones, for voice and data communications. The communication link can be operated as mobile station-to-base station or base station-to-mobile station, or base station-to-base station, or it can be used to create a personal area network (PAN) or a wireless local area network (WLAN).

However, it is unfortunate that currently used mobile and wireless communications systems are not yet standardized, so most of the personal and mobile communications manufacturers choose one version of a wireless communications system to put into their communications products. This restriction means these communications products may only support a particular version of the wireless communications protocols. Often, there is a compatibility problem across different systems, as the system drivers installed in the communications devices at respective ends might not be the same version.

To promote more extensive use of wireless communications products free from the compatibility problems, future communication devices need to be designed for use with at least two different wireless communications systems.

### SUMMARY OF THE INVENTION

The main object of the present invention is to provide a method of managing a wireless repeater having a diverse communications interface capability, whereby the wireless repeater is able to automatically detect and switch to an appropriate wireless communications interface compatible with a target system, that may only support a particular version of wireless communications protocols, so that the user of a personal computing device is able to engage in mobile communications, or to log onto the Internet for web services.

The second object of the present invention is to provide a portable type wireless repeater equipped with a diverse communications interface capability.

The third object of the present invention is to provide a wireless repeater that can be operated as a net phone for VoIP applications, whereby the telephone rates of the user can be considerably reduced.

The fourth object of the present invention is to provide a wireless repeater that has an alert prompting function, whereby the prompter will automatically notify the user of an incoming call by means of vibrations, light beams or ringing tones, or when the repeater ceases the existing communication link.

According to the present invention, the wireless repeater is prepared with multiple communications system drivers, whereby the wireless repeater is able to support many commonly used wireless applications protocols, and these different communications system drivers are controlled by an interface mechanism.

According to the first aspect of the present invention, the method of managing the wireless repeater having a diverse communications interface capability comprises the steps of:
preparing the wireless repeater with at least two different communications system drivers;
creating a different communications module for each wireless communications system serving as a gateway to the particular system, such that the personal computing device through the wireless repeater is able to establish bi-directional communication with the target system, such as a digital computer with a Bluetooth module, mobile communications systems (GPRS/GSM), and a wireless local area network (WLAN);
enabling the wireless repeater to make regular communication links with the personal computing device through the first wireless communications module;
enabling the wireless repeater to make regular communication links with the GPRS/GSM system, and a wireless local area network (WLAN) through the mobile communications module, and to detect whether the data signals come from an incoming call or outgoing call for initiating a call interrupt; and
enabling the wireless repeater to make a connection with the access point of a wireless local area network (WLAN) through a WIFI communications module, on the condition that the personal computing device has successfully logged onto the network.

Since the interface mechanism is embedded in the control circuitry of the wireless repeater, the related hardware and software implementation costs can be considerably reduced.

According to the second aspect of the present invention, a wireless repeater is constructed comprising:
a microprocessor serving as control hub;
a first wireless communications module for enabling the personal computing device to establish bidirectional communication;
a mobile communications module, being connected to the microprocessor, for making connection with two mobile communications systems (GPRS/GSM);
a WIFI communications module, also being connected to the microprocessor, for making connection with the wireless local area network (WLAN); and
a CODEC interface module, being connected between the first wireless communications module and the microprocessor, for encoding and decoding voice data in the data transmission process.

Through the interface mechanism of the microprocessor, the wireless repeater is able to select an appropriate wireless/mobile communications interface from among multiple wireless communications systems for establishing a bi-directional communication with the target system.

The above first wireless communications module can be a Bluetooth module.

The above mobile communications module can be a GSM/GPRS interface.

The above WIFI communications module can be a transceiver for the wireless local area network (WLAN).

The above wireless repeater further includes a third wireless communications module, which enables infra-red transmission of voice and digital data bi-directionally.

The above personal computing device can be a notebook computer, a flat panel computer or a personal digital assistant (PDA).

The present invention enables the personal computing device to call out or receive outside calls through the mobile communications module of the repeater.

According to the third aspect of the present invention, the personal computing device configured with a wireless repeater is able to operate with a net phone (VoIP) for making telephone connection with a remote net phone with the same capability through the call relay function of the repeater, on the condition that the personal computing device has successfully logged onto the network.

The present invention enables the wireless repeater to operate with a headset that can support the high speed port (HSP) for calling out or receiving calls.

According to the fourth aspect of the present invention, the wireless repeater further includes a prompter, also being connected to the microprocessor, which is able to produce vibrations, light beams, or ringing sound to alert the user when a call is received or when the repeater ceases the existing communication link with the wireless local area network (WLAN).

Other objectives, advantages and novel features of the invention will become more apparent from the following detailed description when taken in conjunction with the accompanying drawings.

### BRIEF DESCRIPTION OF THE DRAWINGS

FIG. 1 is conceptual diagram of a possible configuration for the present invention;

FIGS. 2A-2D show a block diagram of the system architecture of the present invention;

FIGS. 3A-3H show a detailed circuit diagram of the microprocessor;

FIGS. 4A-4F show a circuit diagram of the first wireless communications module and part of the CODEC interface module;

FIGS. 5A-5C show a circuit diagram of the rest of the CODEC interface module;

FIGS. 6A-6E show a circuit diagram of the mobile communications module;

FIGS. 7A-7C show a circuit diagram of the WIFI communications module;

FIGS. 8A-8E show a circuit diagram of the prompter; and

FIGS. 9A-9D is a circuit diagram of the power supply module.

### DETAILED DESCRIPTION OF THE PREFERRED EMBODIMENT

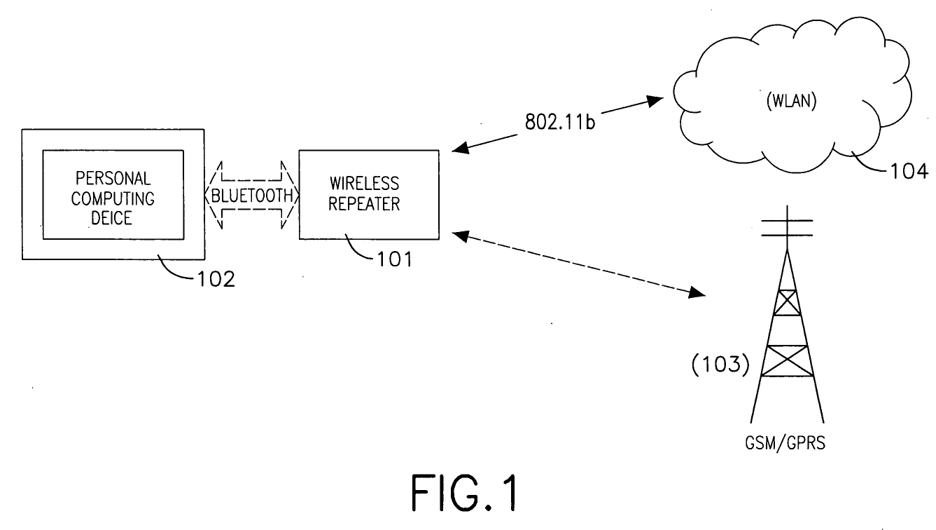

The present invention is illustrated through a preferred embodiment as shown in FIG. 1, in which a wireless repeater (101) serves as an intermediate relay station between a personal computing device (102), a mobile communications network (103), and a wireless local area network WLAN (104); and the wireless repeater (101) has a diverse communications interface capability, enabling the wireless repeater (101) to switch a communications system driver on a regular basis; wherein
the mobile communications network (103) contains two different communications systems: GPRS and GSM.

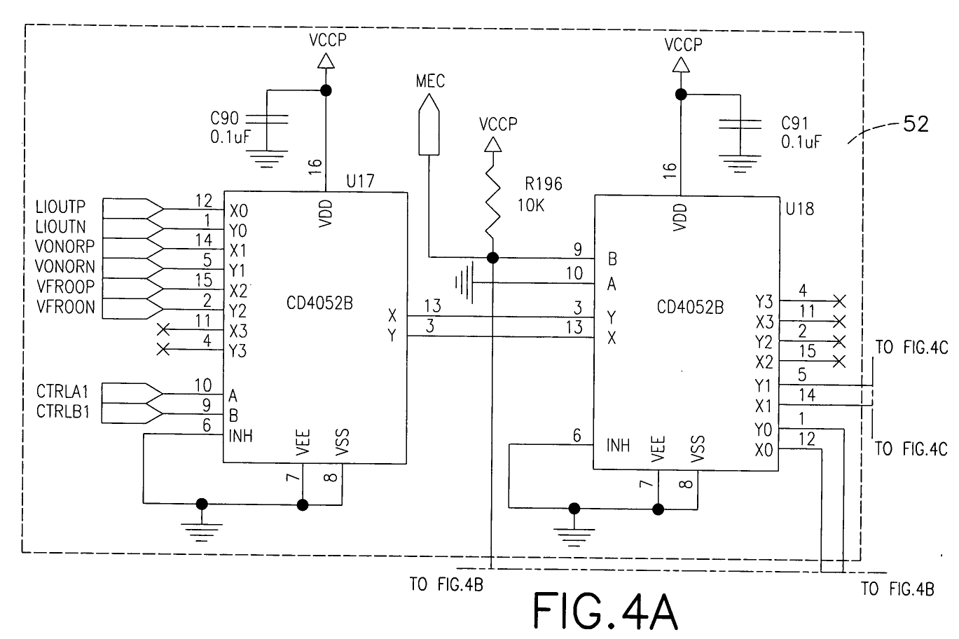

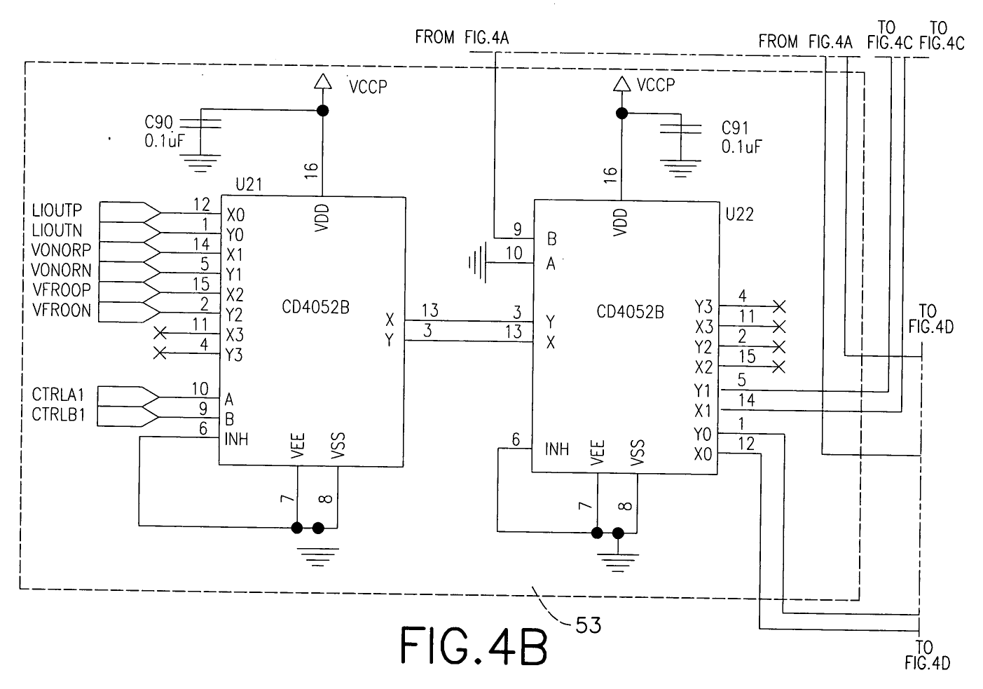

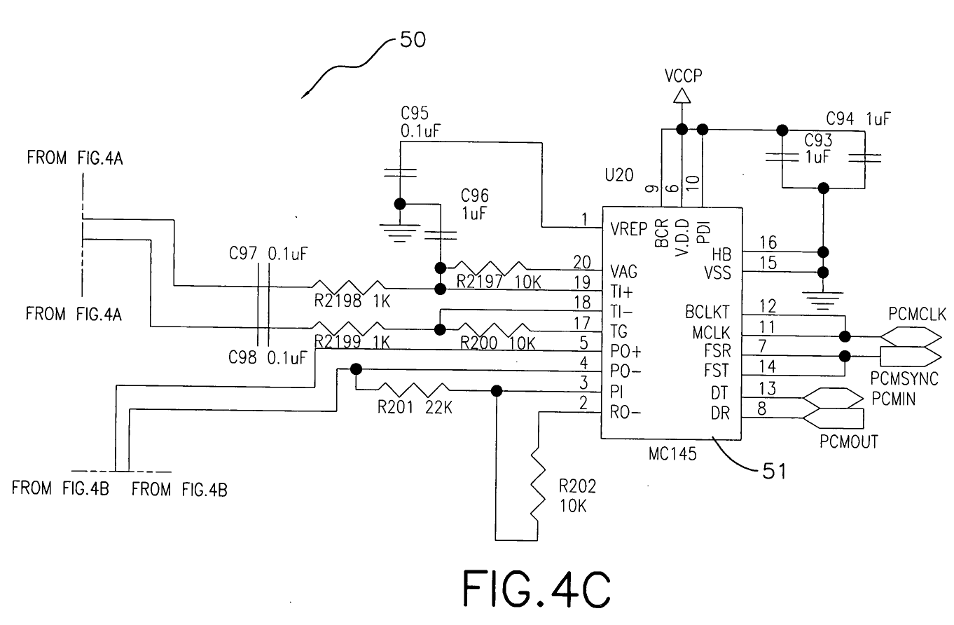

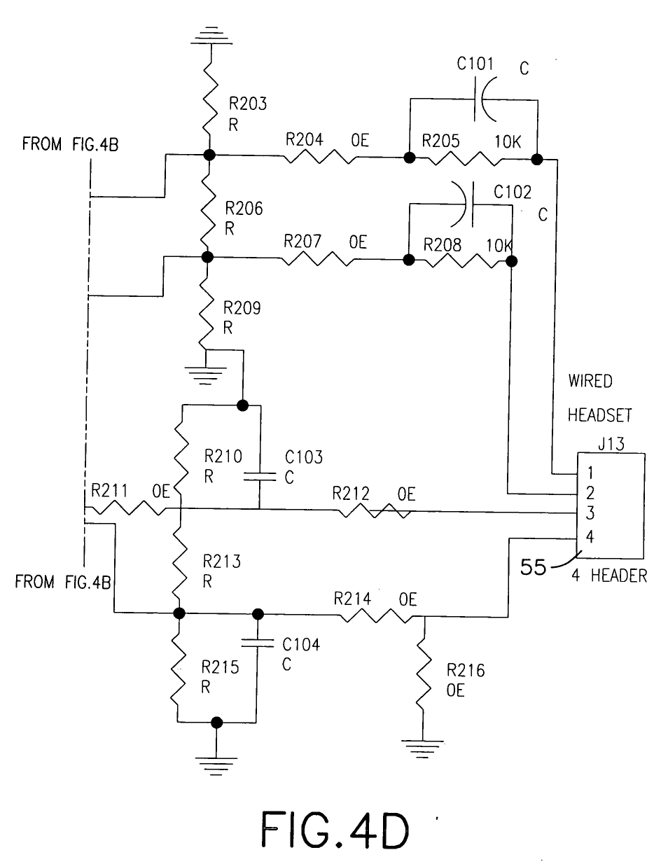

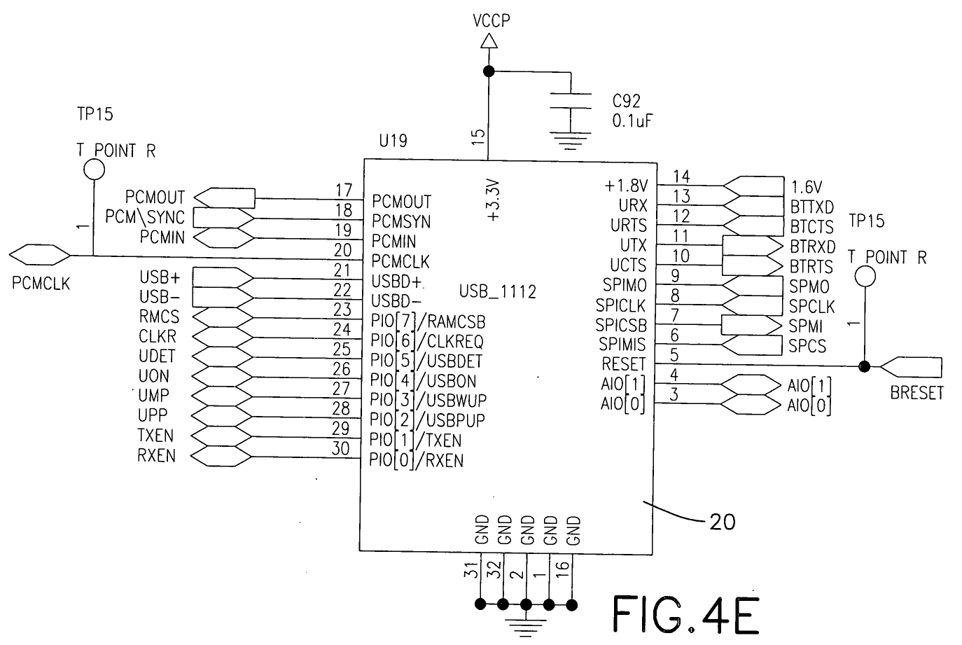

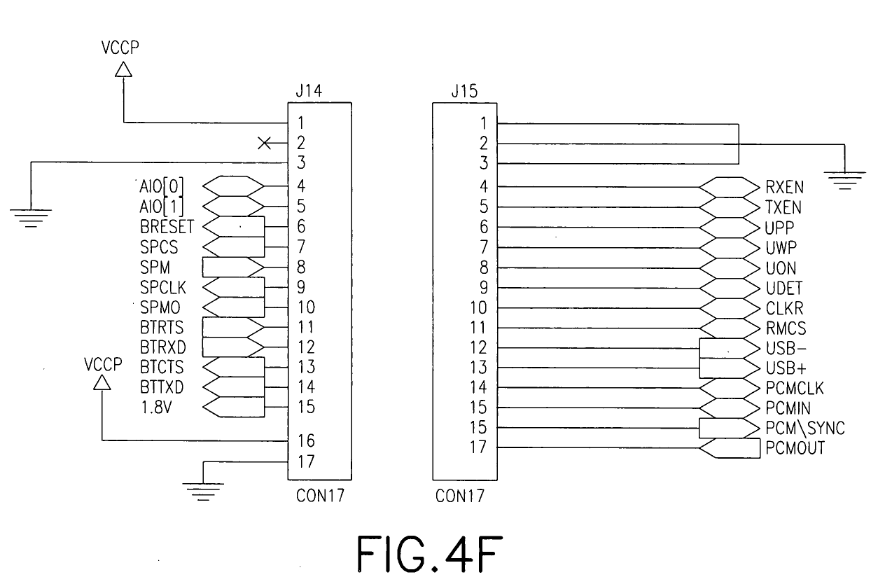

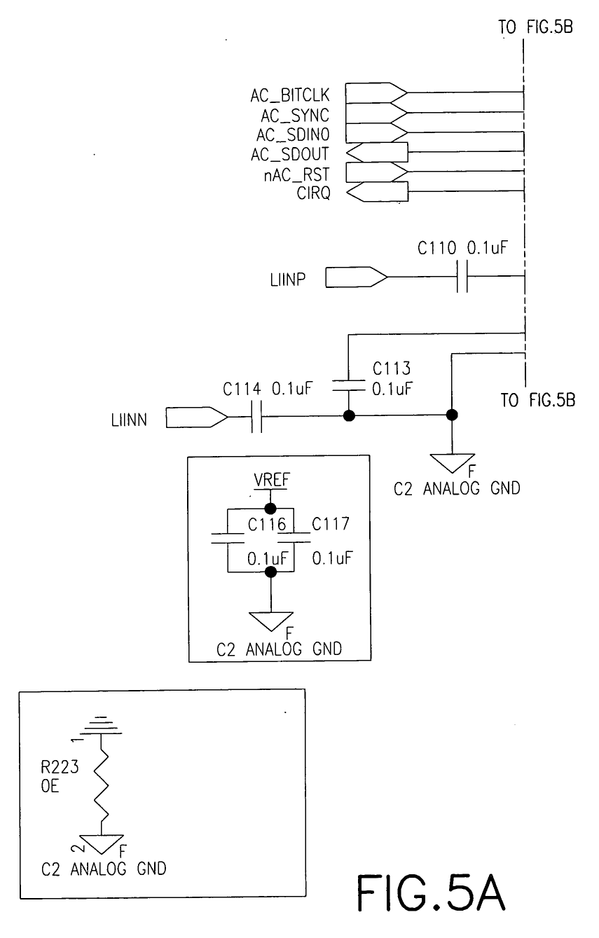

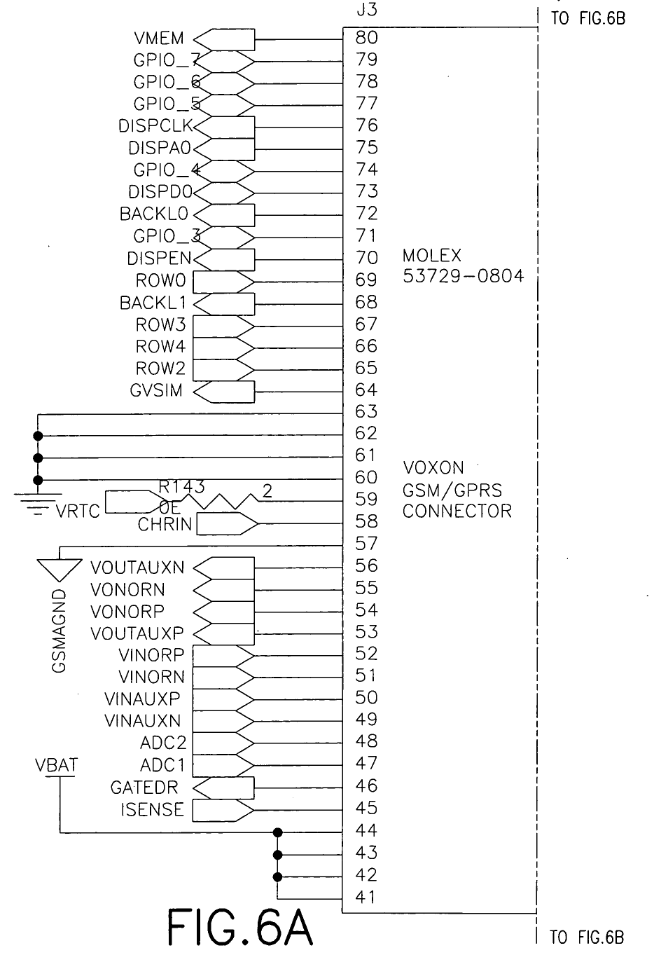

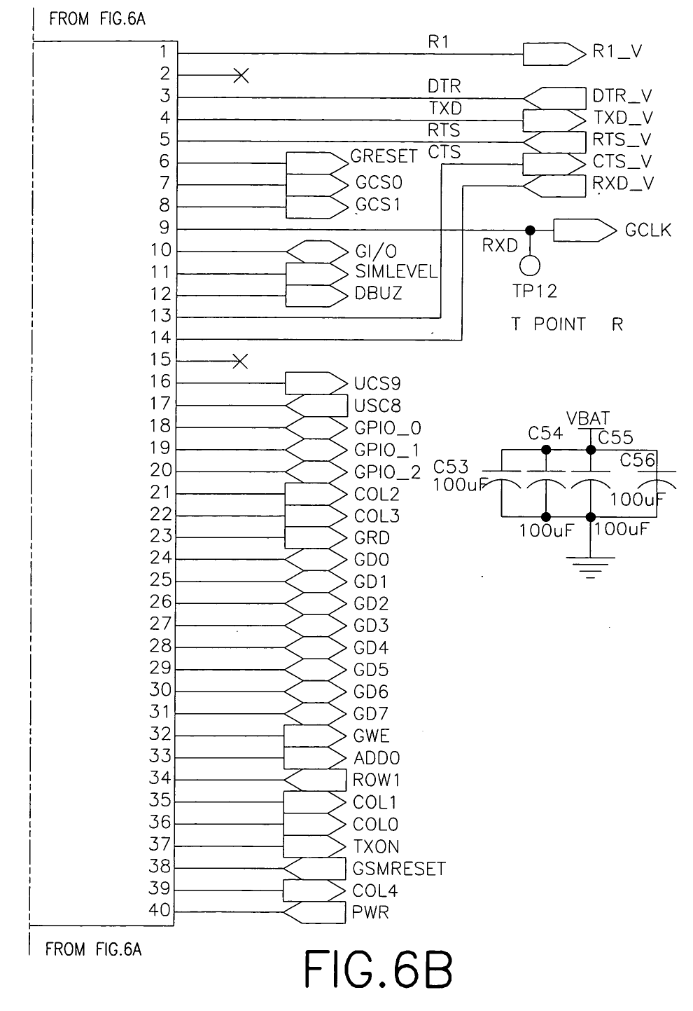

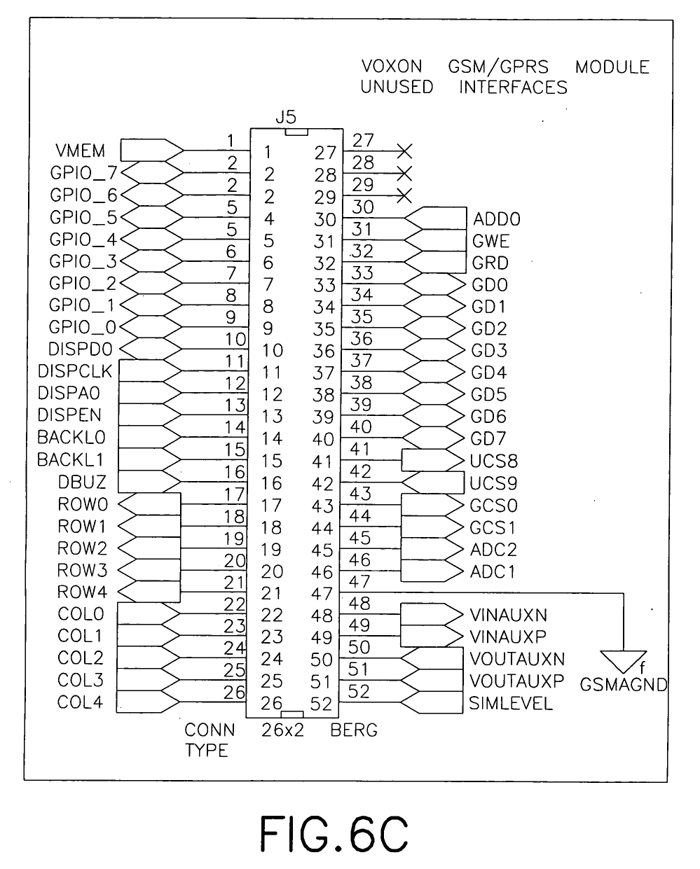

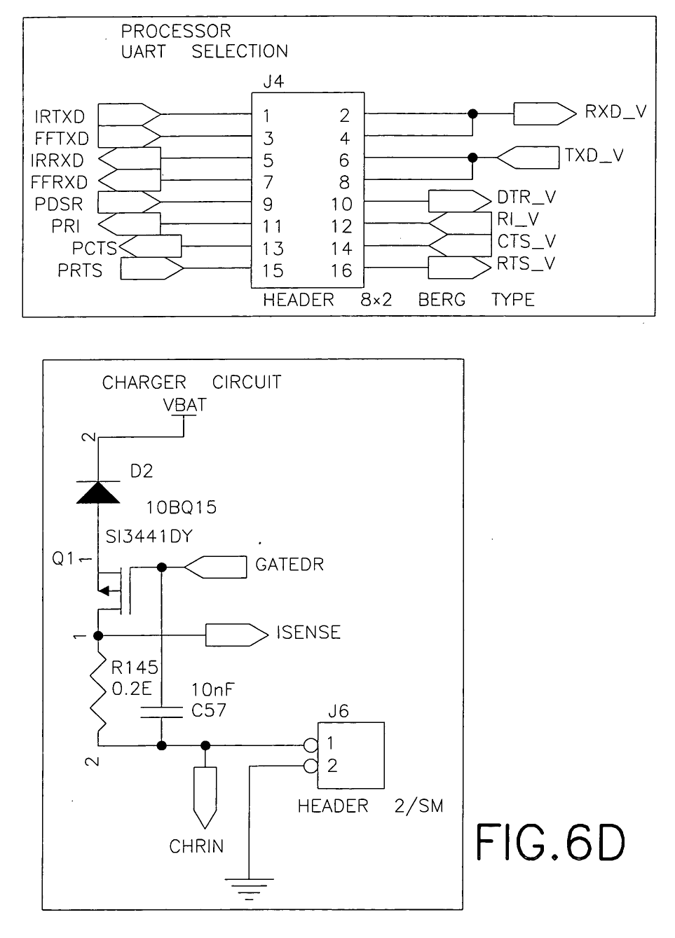

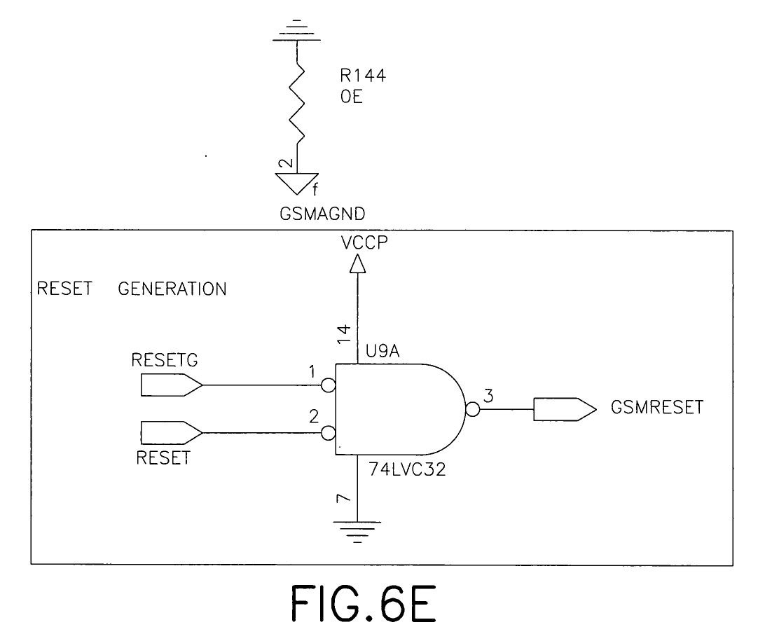

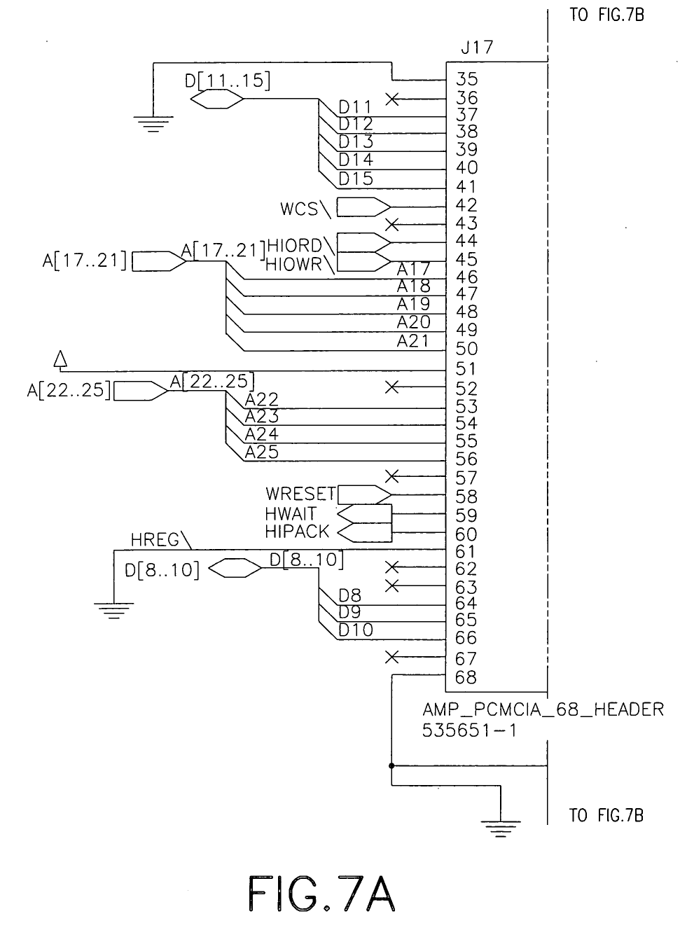

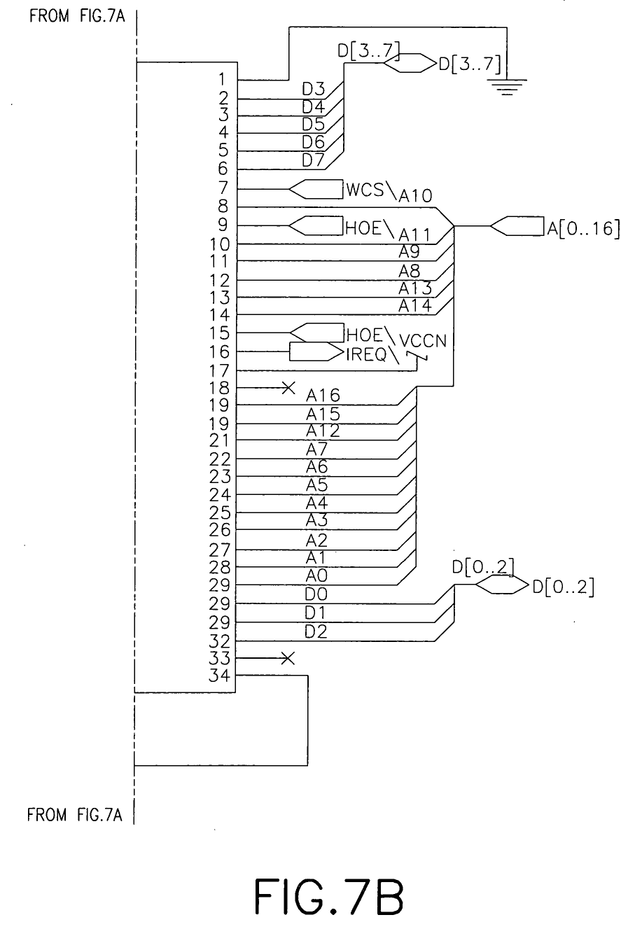

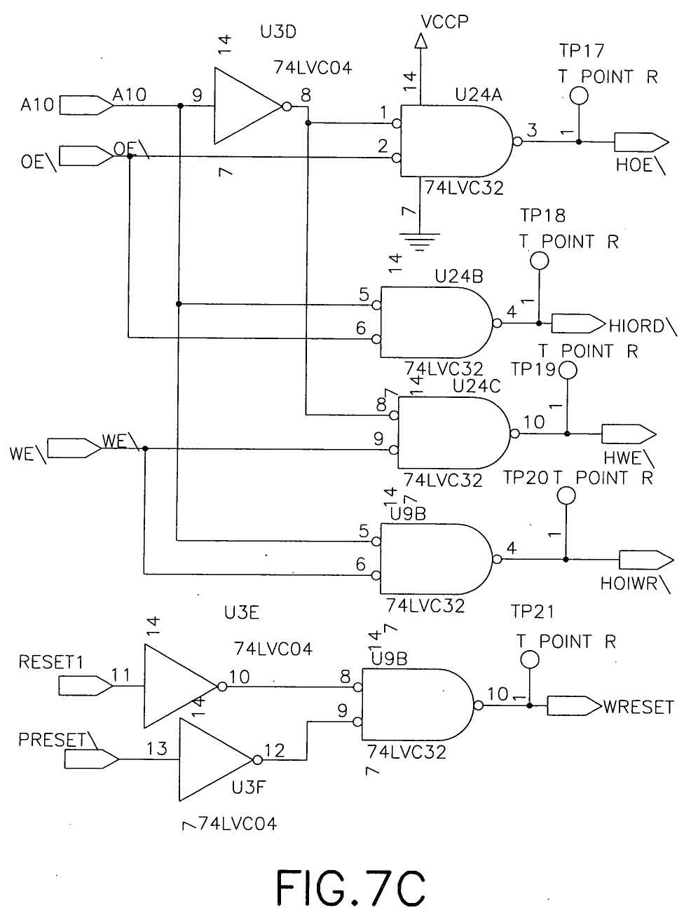

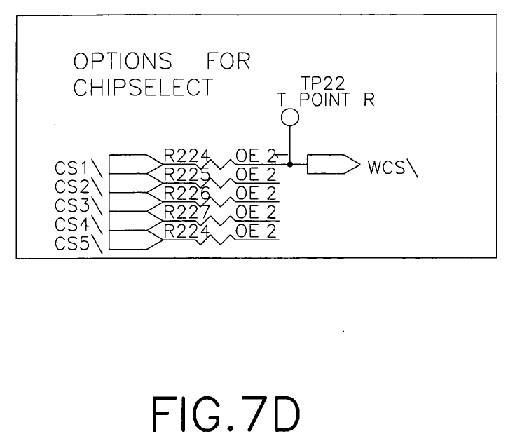

According to the preferred embodiment of the invention, the wireless repeater (101) is set up as follows:
using a first wireless communications module (20), as shown in FIG. 4, to make connection with the personal computing device (102);
using a mobile communications module, as shown in FIGS. 6A-6E, to make connection with the two systems (GPRS/GMS) in the mobile communications network (103); and
using a WIFI communications module, as shown in FIGS. 7A-7C, to make a connection with the wireless local area network WLAN (104).

Such being the case, the wireless repeater (10) is able to establish regular communication links with the personal computing device (102) through the first wireless communications module (20), through which the personal computing device (102) is able to establish regular communication links with a mobile communications network (GPRS/GSM) or a wireless local area network (WLAN) (104) using the mobile communications module or the WIFI communications module.

The mobile communications network (103) includes a GPRS system and a GSM system, wherein the GPRS system maintains a regular communication link with the wireless repeater (101), and the personal computing device (102) is able to send out or receive electronic mails or use web services through the first wireless communications module (20) of the wireless repeater (101).

The personal computing device (102) is configured with the wireless repeater (101) such that the personal computing device (102) is able to call out or receive phone calls to/from the GSM system through the first wireless communications module (20) and second mobile communications module. When a call request is received, the existing link between the wireless repeater (101) and the GPRS system is halted temporarily, and the system enters a waiting period until the termination of the incoming call and then resumes the previous GPRS system automatically.

If the wireless repeater (101) is not located in the broadcasting range of the WLAN (104), the personal computing device (102) is still able to call out or receive calls through the first wireless communications module (20) using the GSM system. Once the wireless repeater (101) is within the broadcasting range of the WLAN (104) and is successfully authenticated after log-in, the user can use the personal computing device (102) through the wireless repeater (101) to make a connection with the WLAN (104) for placing a telephone call through the net phone (VoIP) to a remote house phone or net phone with the same capability.

In the preferred embodiment, the above personal computing device (102) can be either a notebook computer, a flat panel computer, or a personal digital assistant (PDA), and the control signals and voice data between the wireless repeater (101) and the personal computing device (102) are transmitted through a serial parallel port (SPP) and a high speed port (HSP), enabling the personal digital assistant (PDA) to call out or receive calls directly. Alternatively, the wireless repeater (101) can also have a Bluetooth headset (BTHS) to call out or receive calls, as long as the wireless repeater (101) and the Bluetooth headset (BTHS) are connected by a high speed port (HSP).

Besides the personal digital assistant (PDA), the above personal computing device (102) can also be notebook computer or a flat panel computer.

From the foregoing, it becomes apparent, in the present invention, the wireless repeater (101) serves as an intermediate relay station between a base station and a mobile station, and the personal computing device (102) configured with the wireless repeater (101) can automatically select an appropriate communications system driver compatible with the target system from among multiple communications system drivers, for bi-directional communication, thus obviating the compatibility problem in association with different versions of wireless communications protocols.

Since the interface mechanism and multiple communications driver circuits are installed in the wireless repeater, the related hardware and software implementation costs can be considerably reduced.

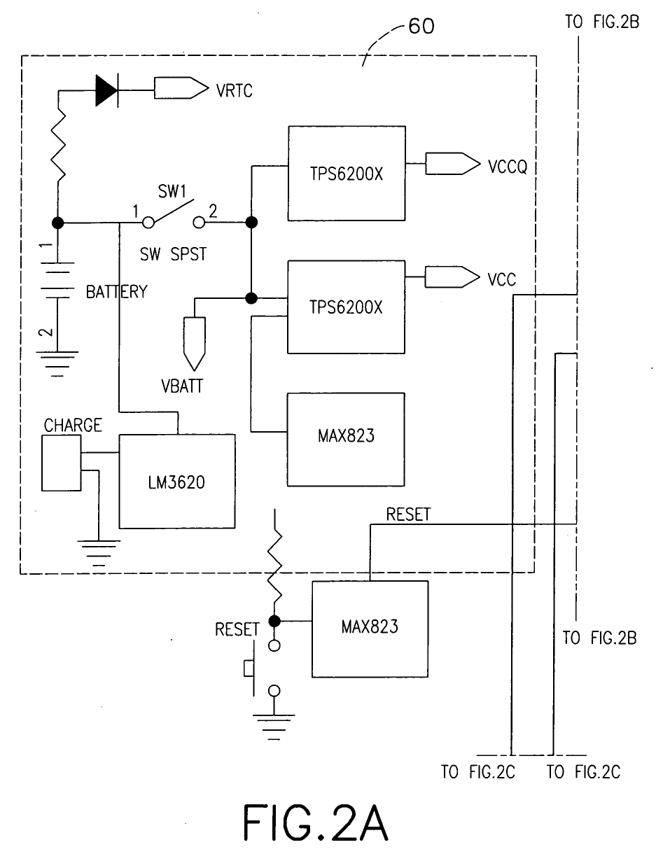

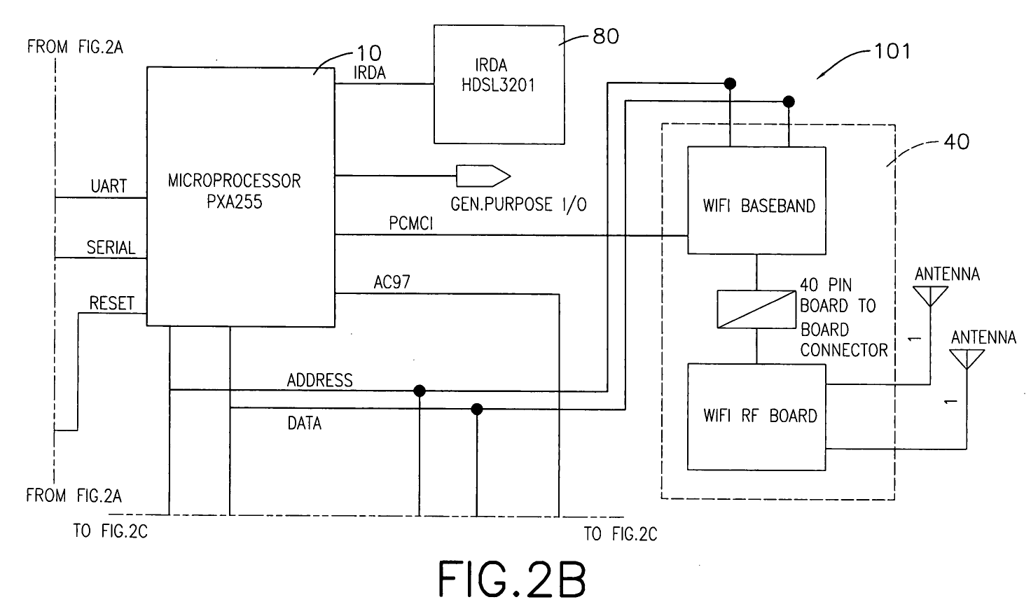

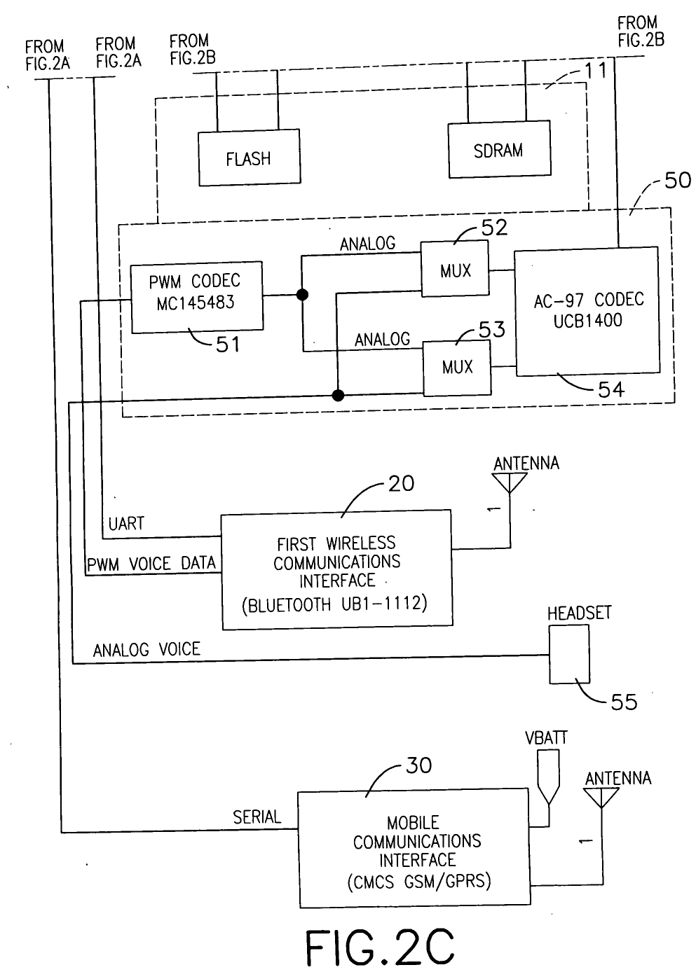

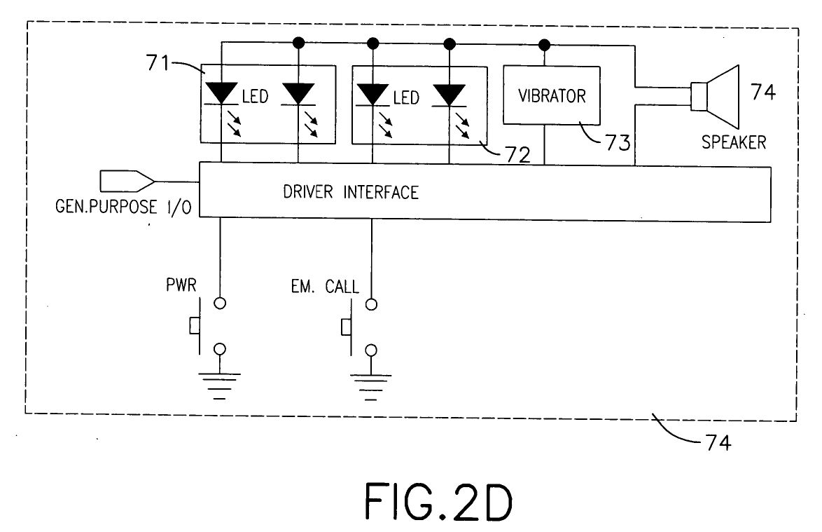

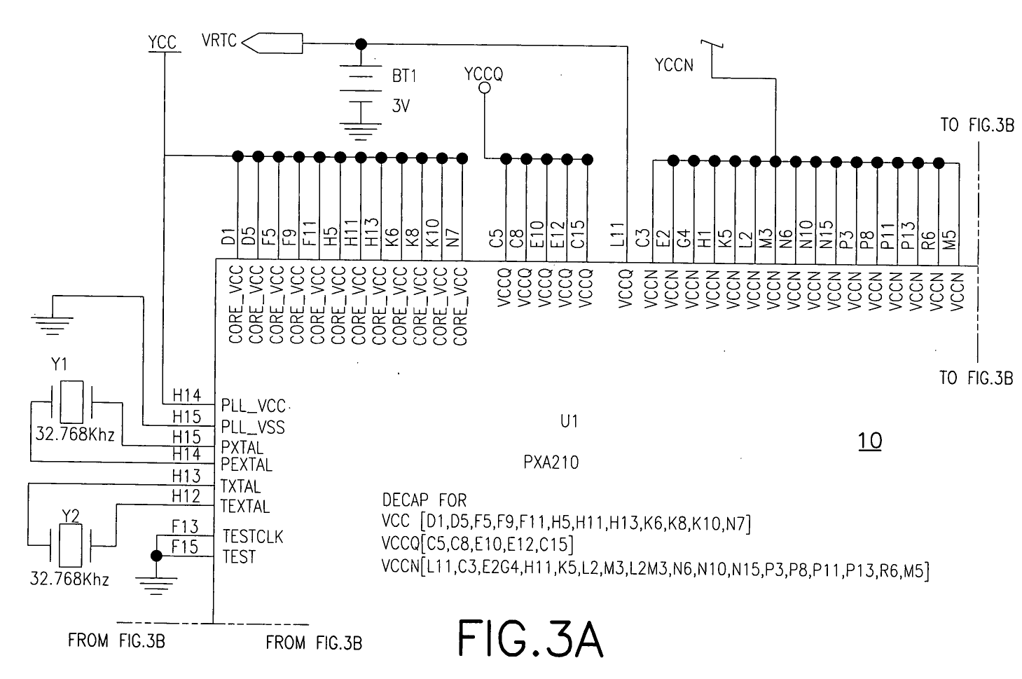

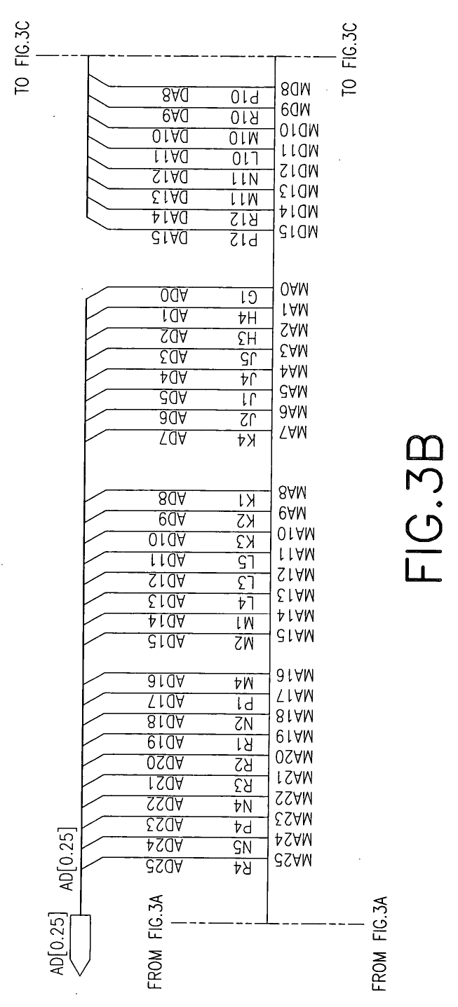

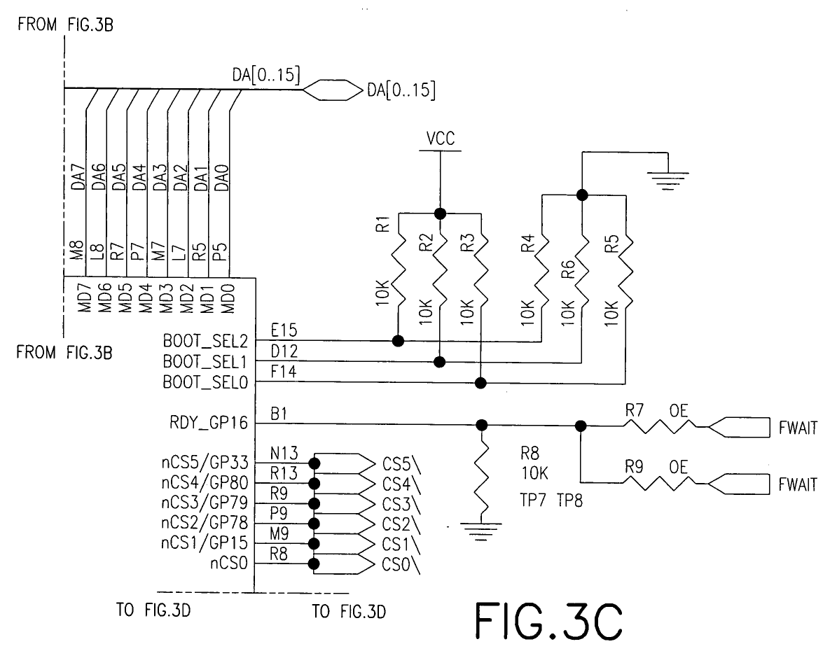

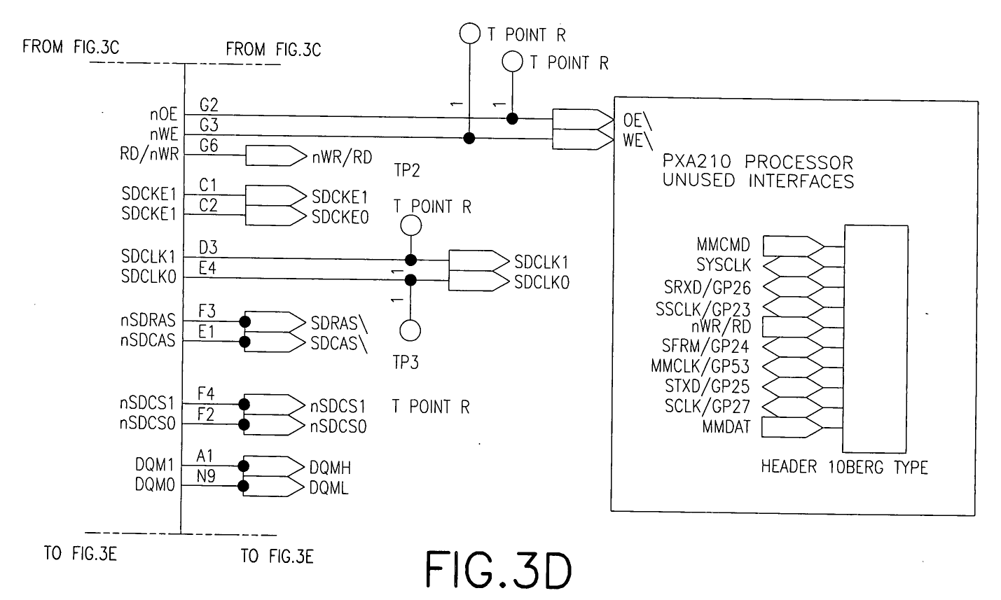

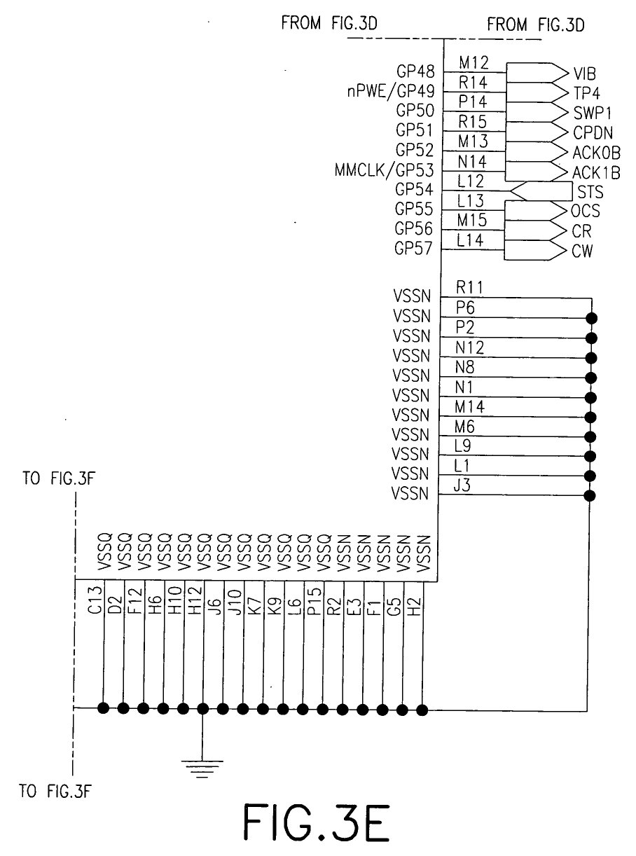

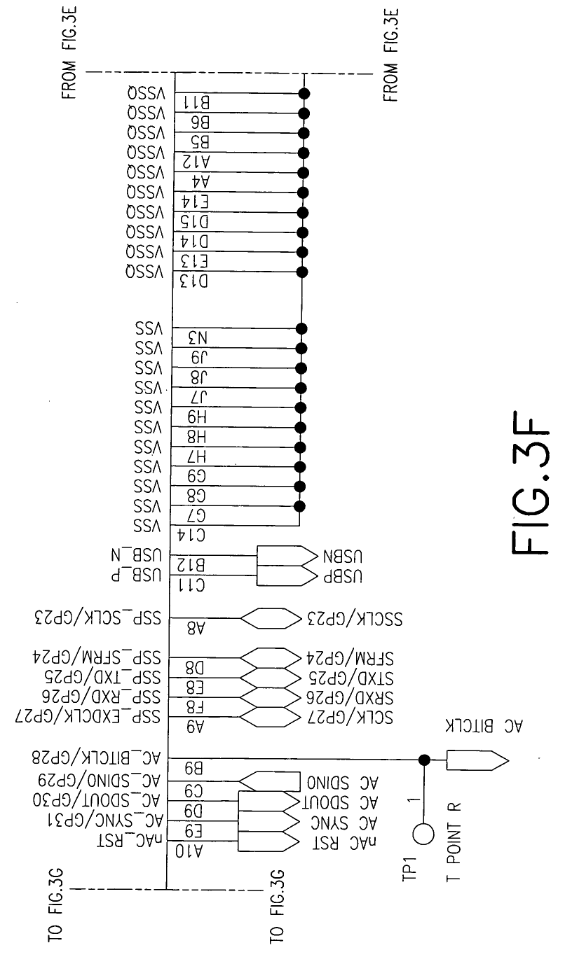

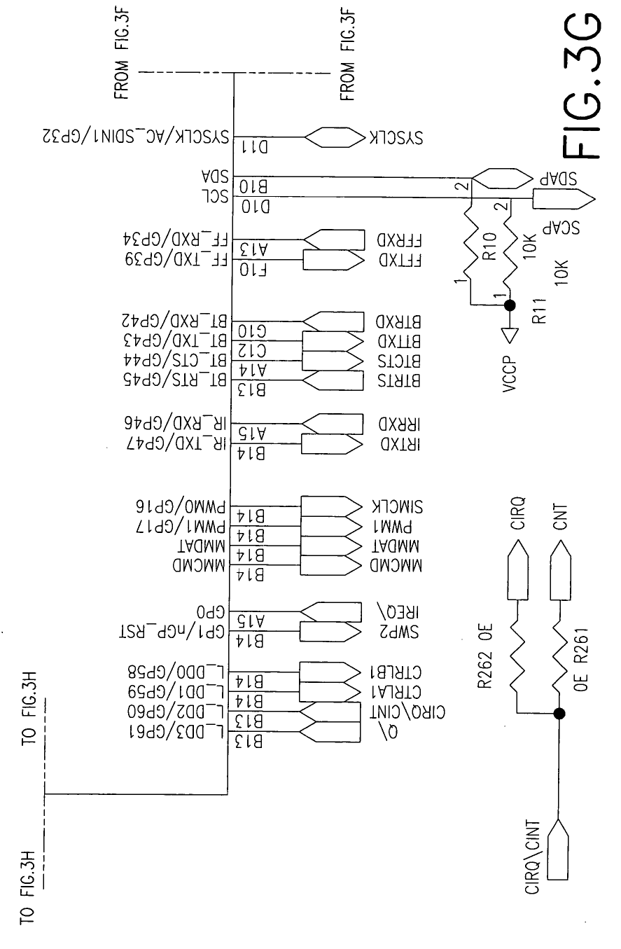

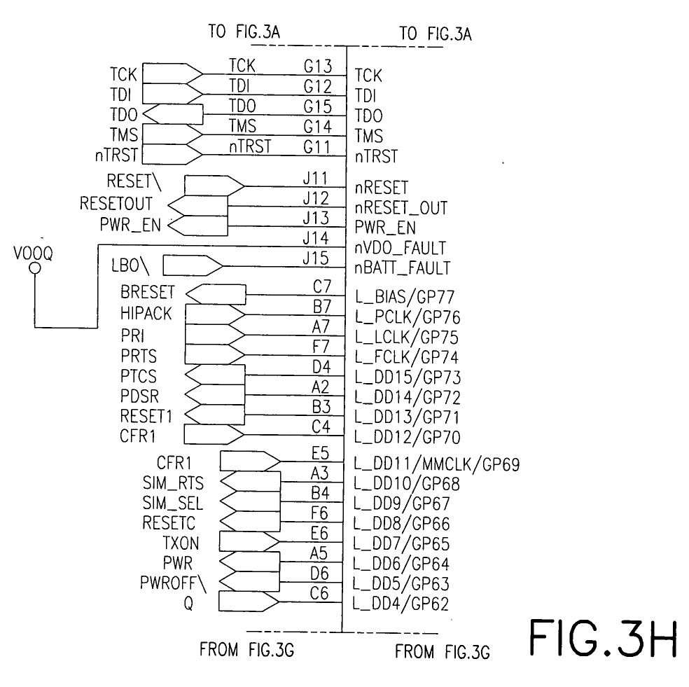

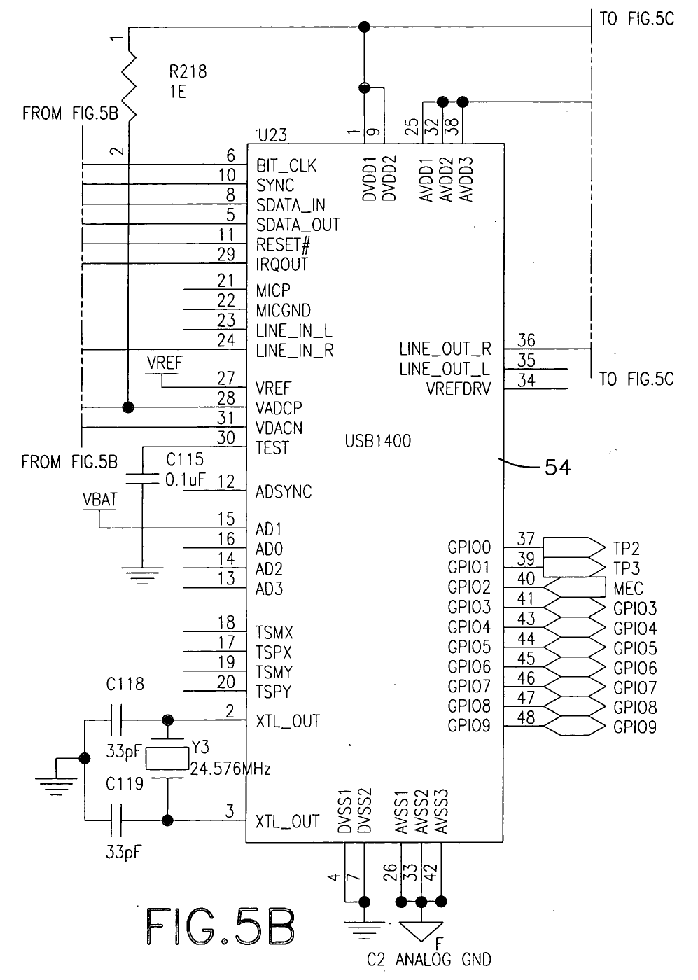

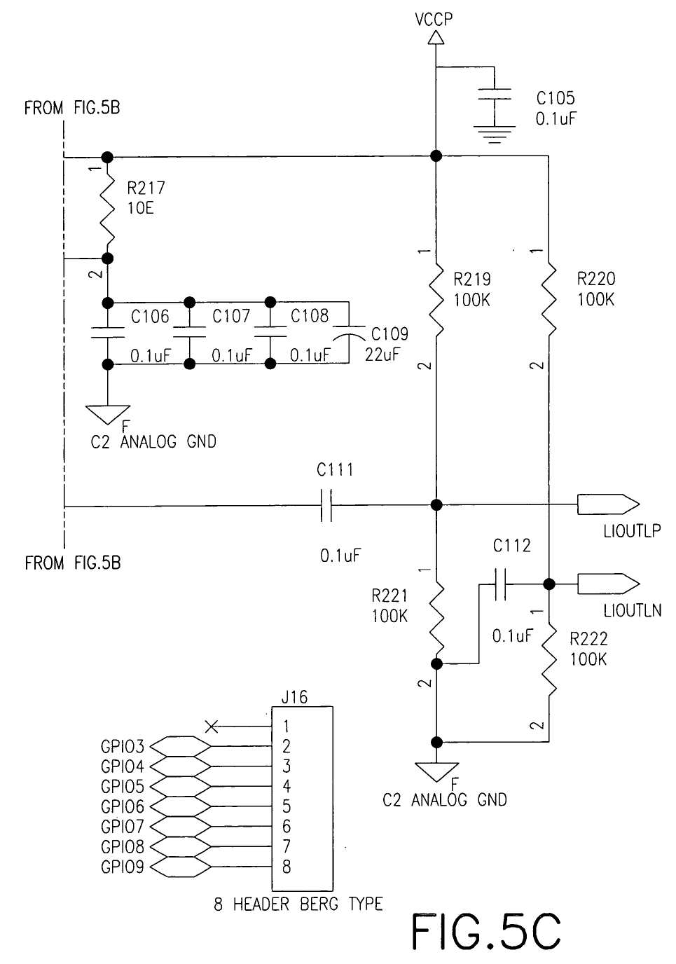

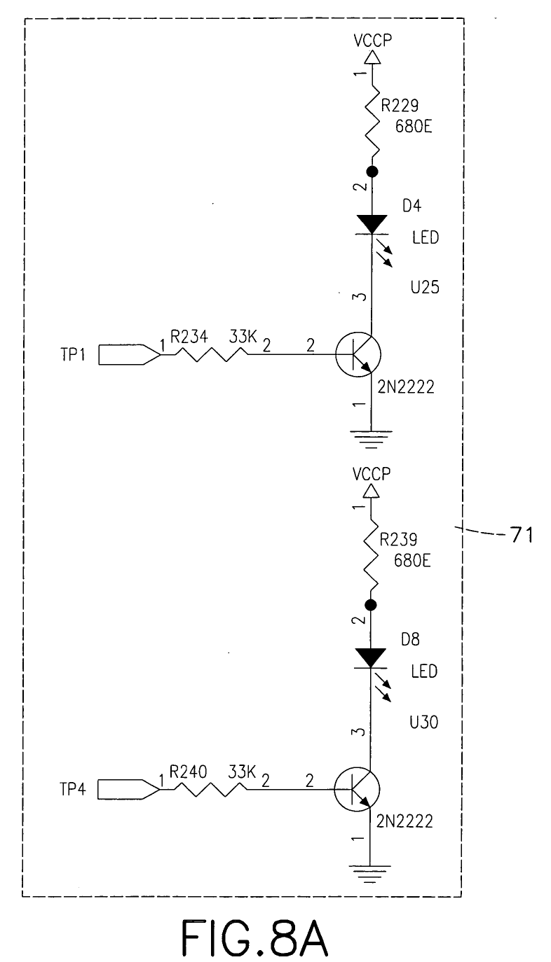

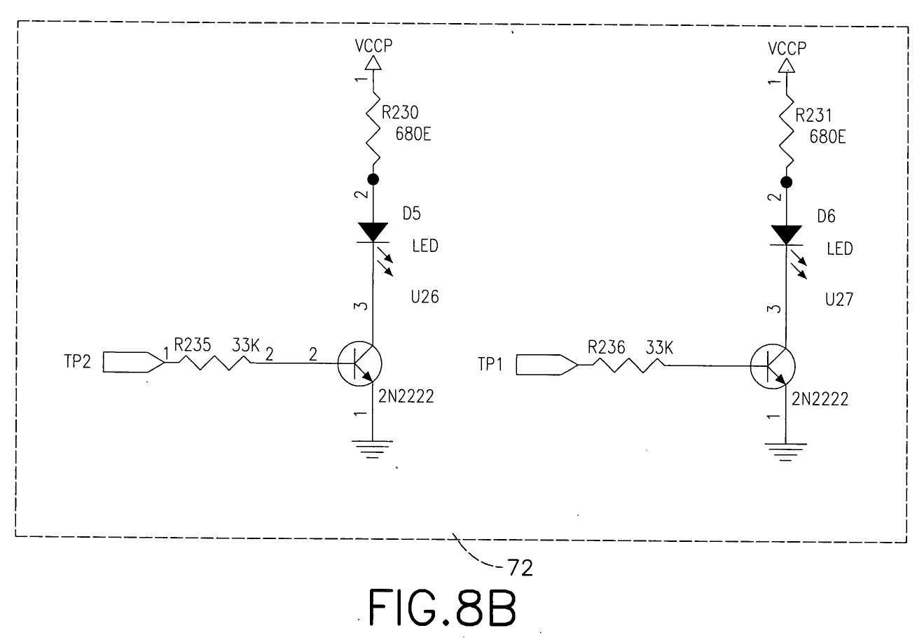

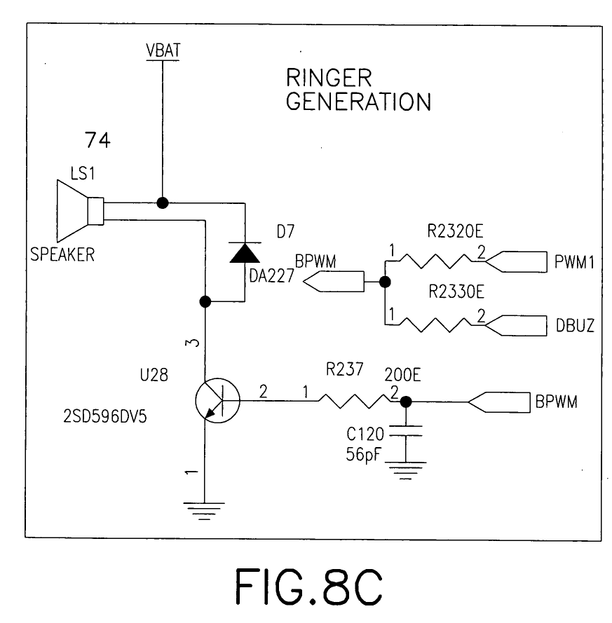

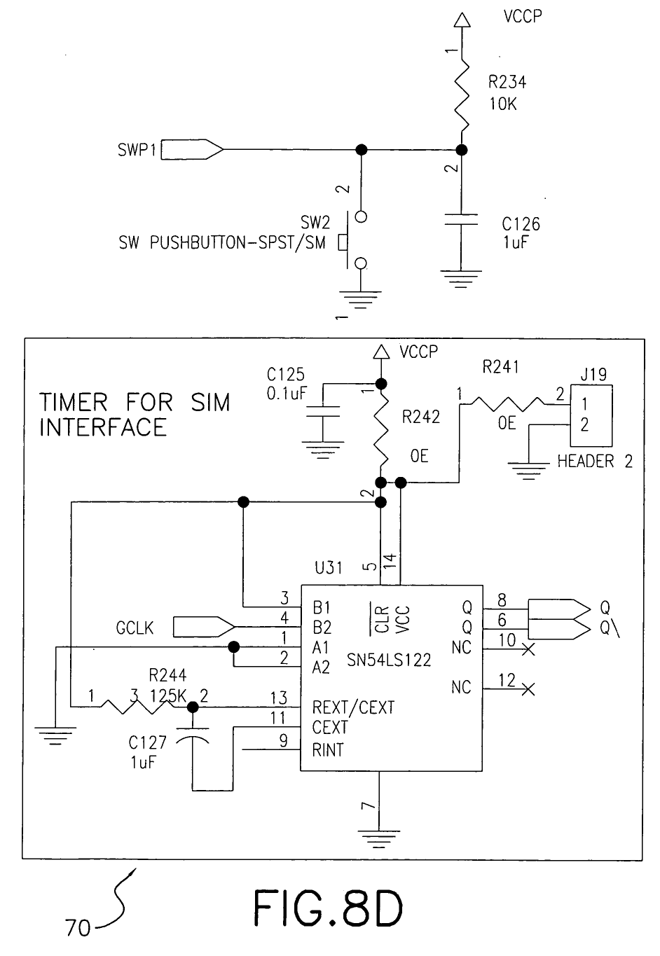

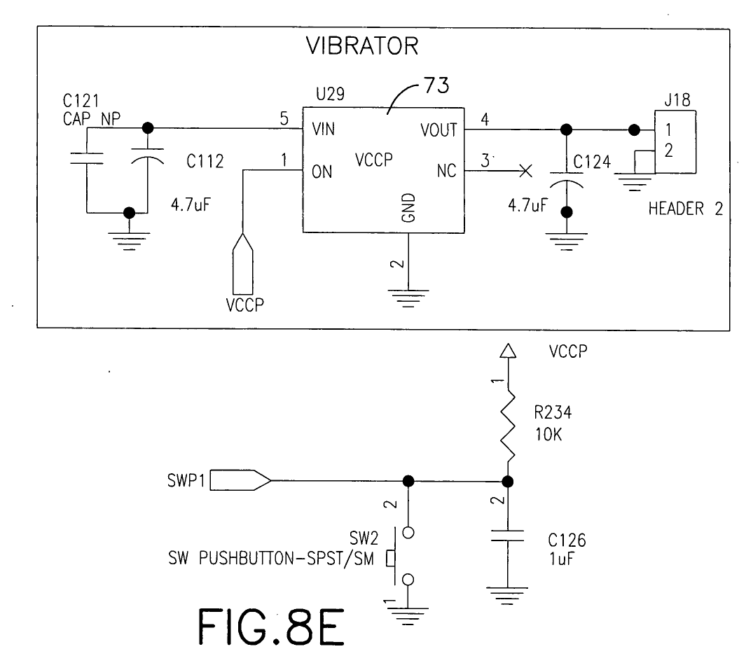

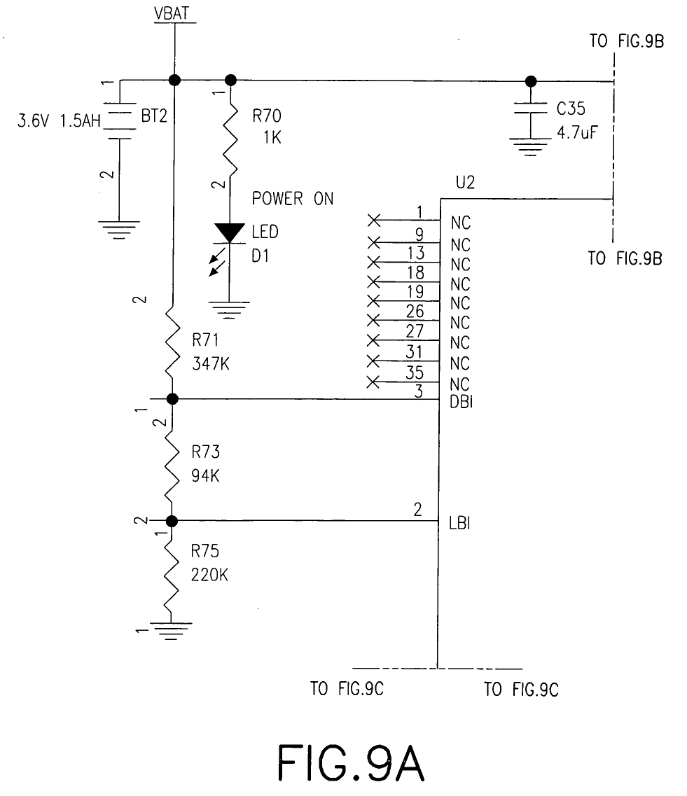

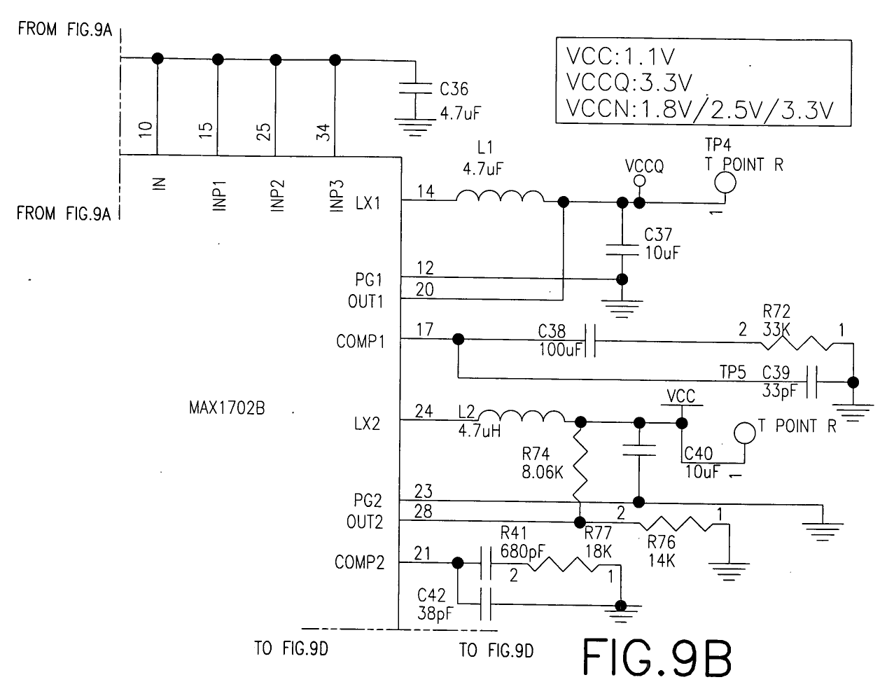

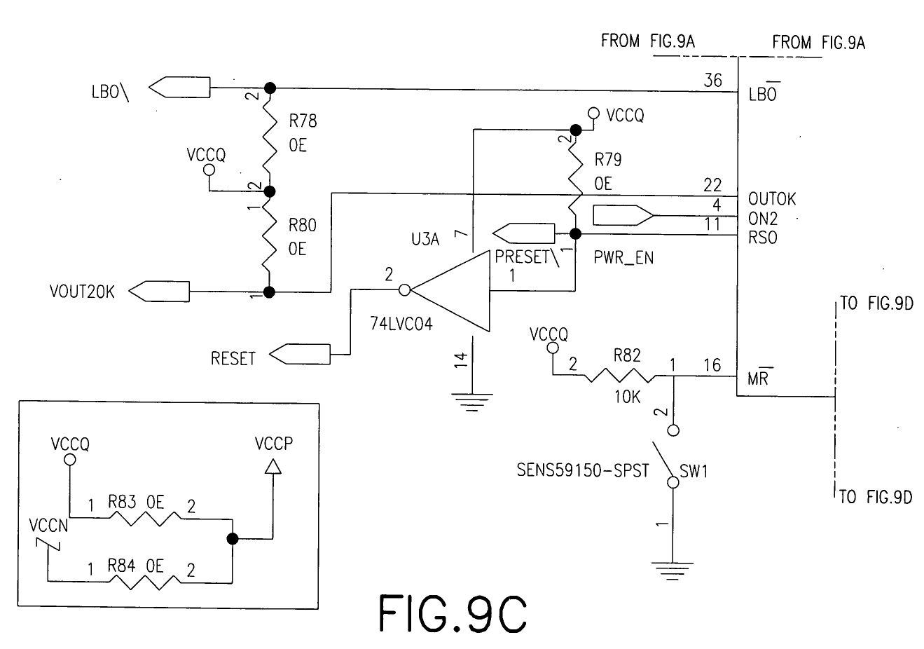

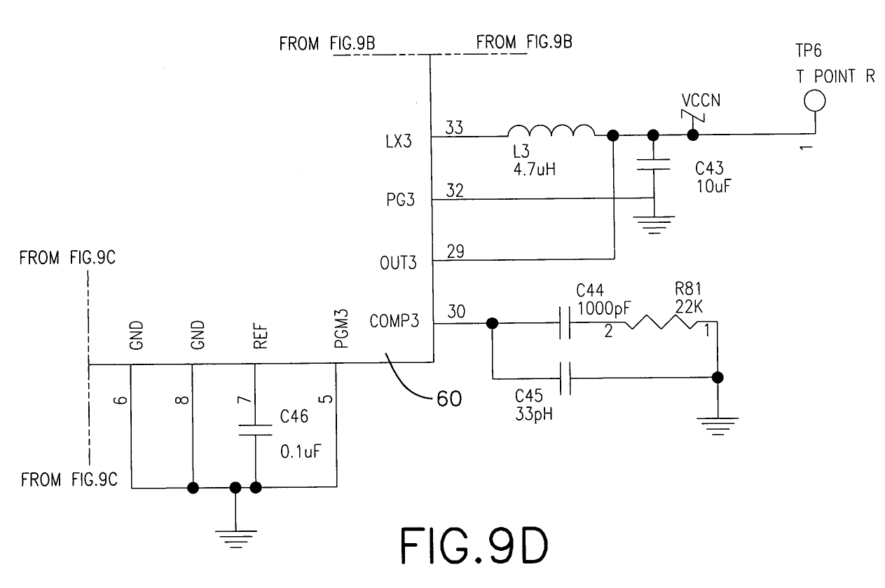

It is possible to use either the GSM system or the net phone (VoIP) for making telephone connection with the other phone on the remote end. However, if the user chooses to use the net phone (VoIP) instead of the GSM system, the telephone bill can be considerably reduced. To realize the above scheme, the architecture of the wireless repeater (101), in one preferred embodiment as shown in FIGS. 2A-2D, comprises:
a microprocessor (10), as shown in FIGS. 3A-3H, serving as the control hub;
a first wireless communications module (20), as shown in FIGS. 4A-4F, for making connection with the personal computing device (102);
a mobile communications module (30), being connected to the microprocessor (10), for making connection with the two mobile communications systems (GPRS/GSM);
a WIFI communications module (40), being connected to the microprocessor (10), for making connection with a WLAN (104);
a CODEC interface module (50), as shown in FIGS. 5A-5C, being connected in between the first wireless communications module (20) and the microprocessor (10), for encoding and decoding voice and digital data in the data transmission process;
a power supply module (60), as shown in FIGS. 9A-9D, for providing the operating voltage to all system components;
a prompter (70), as shown in FIGS. 8A-8E, being connected to the microprocessor (10), for generating vibrations, ringing tones or light beams to alert the user when an incoming call is received, or when the wireless repeater (101) has ceased the existing link with the WLAN (104).

The first wireless communications module (20) can be a Bluetooth module.

The mobile communications module (30) can be a GSM/GPRS interface that supports GPRS and GSM systems.

The WIFI communications module (40) can be transceiver for a WLAN (104) that supports 802.11b communications protocols.

The CODEC interface module (50), as shown in FIGS. 4, 5 is formed by a PWM CODEC (51), a pair of multiplexers (52)(53) and a voice CODEC (54), wherein the PWM CODEC (51) is connected to the first wireless communications module (20) and further through the multiplexer (52) (53) connected to the voice CODEC (54), and through the voice CODEC (54) connected to the microprocessor (10), wherein one multiplexer (53) is connected to a headset plug-in socket (55), whereby the multiplexers (52) (53) are responsible for switching the audio data transmission path between the first wireless communications module (20) and the headset connected through the voice CODEC (51) and the microprocessor (10).

The prompter (70), as shown in FIG. 8, is formed by a pair of indicator LEDs (71) (72), a vibrator (73), and a speaker (74) and related driver circuits, wherein the driver circuit is connected to the microprocessor (10), whereby when an incoming call is received by the wireless repeater (101), the speaker (74) starts to emit ringer tones; alternatively, the user can choose to use the vibrator (73) to produce rhythmic vibrations to alert the user of incoming calls; also, the prompter (70) is also activated when the wireless repeater (101) ceases the existing link with the WLAN (104).

Further, the wireless repeater (101) can also have a third wireless communications module (80), as in the preferred embodiment, which is an infra-red transmission interface, being connected to the microprocessor (10), for data communications bi-directionally.

The microprocessor (10) is also connected to a memory unit (11), wherein the memory unit (11) has flash RAM and DRAM for saving operation data and program instructions.

From the foregoing, the present invention has constructed a wireless repeater prepared with multiple mobile/wireless communications system drivers, whereby the microprocessor will be able to choose an appropriate wireless or mobile communications system driver compatible with the target system to establish bi-directional communication The wireless repeater, in accordance with the present invention, has the following advantages over prior art:
1. Versatility—Providing a choice of an appropriate wireless communication system driver from among several resident in the wireless repeater for preparing bi-directional communication with a target system that may only support a particular version of wireless communications protocols;
2. Low Use-Costs—Being able to use the net phone (VoIP) through a wireless local area network (WLAN) to establish a communication link between with a remote phone for reduced telephone rates;
3. Cost Effective System Enhancement—Having multiple communications system drivers integrated into the wireless repeater can reduce the software and hardware implementation costs and improve the system performance;
4. Mobility: the portable design of the wireless repeater provides the greatest mobility for a communication link between the base station and the mobile station.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of managing a wireless repeater (101) with a diverse communications interface capability, comprising the steps of:
preparing a wireless repeater (101) with multiple wireless communication system drivers, each of the multiple wireless communication system drivers supporting a different version of wireless communications protocols, to enable the personal computing device (102) to establish bi-directional communication with a target system, that may only support a particular version of wireless communications protocols, operating on a personal communications device, a mobile communications system, or a WLAN;
enabling the wireless repeater (101) to establish regular communication links with the personal computing device (102) through a first wireless communications module (20);
enabling the wireless repeater (101) to establish regular communication links with a mobile communications network (103) through the mobile communications module (30), and also to detect whether the call is an incoming call or an outgoing call for initiating a call interrupt; and
enabling the wireless repeater (101) to establish a communication link with an access point of the WLAN (104) through a WIFI communications module (40), on the condition that the personal computing device (102) has successfully logged onto the network.

2. The method of managing a diverse wireless repeater (101) according to claim 1, wherein the personal computing device (102) is configured with the wireless repeater (101) such that the personal computing device (102) is able to establish communication links with the GPRS system to transmit or receive electronic mails and perform web site services.

3. The method of managing a diverse wireless repeater (101) according to claim 1, wherein the personal computing device (102) is configured with the wireless repeater (101) such that the personal computing device (102) is able to establish communication links with the GSM system to make an outgoing call or receive an incoming call.

4. The method of managing a diverse wireless repeater (101) according to claim 2, wherein the personal computing device (102) is configured with the wireless repeater (101) such that the personal computing device (102) is able to establish communication links with the GSM system to make an outgoing call or receive an incoming call.

5. The method of managing a diverse wireless repeater (101) according to claim 3, wherein the personal computing device (102) is configured with the wireless repeater (101) such that the personal computing device (102) through the relay function of the wireless repeater (101) can use a net phone (VoIP) to make connection with another phone, on the remote end and with the same capability, on the condition that the personal computing device (102) has successfully logged onto the network.

6. The method of managing a diverse wireless repeater (101) according to claim 4, wherein the personal computing device (102) is configured with the wireless repeater (101) such that the personal computing device (102) can use a net phone (VoIP) to make connection with another phone with the same capability on *the remote end, on the condition that the personal computing device (102) has successfully logged onto the network.

7. The method of managing a diverse wireless repeater (101) according to claim 1, wherein the personal computing device (102) is configured with the wireless repeater (101) such that the user is able to use a headset with a high speed port (HSP) to make telephone calls or receive calls.

8. A wireless repeater (101) with a diverse communications interface capability, comprising:
a microprocessor (10) serving as a control hub;
a first wireless communications module (20) for establishing bi-directional communication with a personal computing device (102);
a mobile communications module (30), being connected to the microprocessor (10), for making connection with two mobile communications systems (GPRS/GSM);
a WIFI communications module (40), being connected to the microprocessor (10), for making connection with a WLAN (104);
a CODEC interface module (50), being connected in between the first wireless communications module (20) and the microprocessor (10), for encoding and decoding voice signals in the data transmission process;
whereby the microprocessor (10) can automatically detect and switch to an appropriate wireless/mobile communications system to match the target system on the remote, that may only support a particular version of wireless communications protocols, for bi-directional communication between the personal computing device (102) and the target system.

9. The wireless repeater (101) according to claim 8, wherein the first wireless communications module (20) can be a Bluetooth module.

10. The wireless repeater (101) according to claim 8, wherein the mobile communications module (30) is a GSM/GPRS interface.

11. The wireless repeater (101) according to claim 8, wherein the WIFI communications module (40) is a transceiver for a wireless local area network WLAN.

12. The wireless repeater (101) according to claim 8, wherein the wireless repeater (101) further includes a third wireless communications module (80) that is an infra-red transmission interface for transmission of voice and digital data.

13. The wireless repeater (101) according to claim 8, wherein the CODEC interface module (50) is formed by a PWM CODEC (51) and a voice CODEC (54), wherein the PWM CODEC (51) is connected to the first wireless communications module (20) and through the voice CODEC (54) is further connected to the microprocessor (10).

14. The wireless repeater (101) according to claim 13, wherein the CODEC interface module (50) further has a pair of multiplexers (52)(53) installed in between the PWM CODEC (51) and the voice CODEC (54), wherein one of the two multiplexers (52)(53) is connected to a headset plug-in socket (55), whereby the multiplexer (52)(53) can switch the voice data transmission path between the first wireless communications module (20) and the headset connected through the voice CODEC and the microprocessor (10).

15. The wireless repeater (101) according to claim 8, wherein the microprocessor (10) is further connected to a prompter (70), whereby the prompter (70) can generate vibrations, light beams, or ringing tones to notify the user when an incoming call is received, or when the wireless repeater (101) has ceased the existing link with the WLAN (104).

16. The wireless repeater (101) according to claim 15, wherein the prompter (70) is formed by a pair of indicator LEDs (71) (72), a vibrator (73), and a speaker (74) and related driver circuits.

17. The wireless repeater (101) according to claim 8, wherein the personal computing device (102) is a notebook computer.

18. The wireless repeater (101) according to claim 8, wherein the personal computing device (102) is a flat panel computer.

19. The wireless repeater (101) according to claim 8, wherein the personal computing device (102) is a personal digital assistant (PDA).

20. The wireless repeater (101) according to claim 8, wherein the microprocessor (10) is connected to a memory unit (11), wherein the memory unit (11) is installed with flash RAMs and DRAMs.

21. The wireless repeater (101) according to claim 8, wherein the wireless repeater (101) further includes a power supply module (60) for providing the operating voltage to all system components.
